(19) United States
(12) Patent Application Publication
(10) Pub. No.: US 2023/0026384 A1
(43) Pub. Date: Jan. 26, 2023

(54) DEVICE FOR DETERMINING A FACE OF A DICE RESTING ON A SURFACE ALLOWING AN OPTICAL SIGNAL TO PASS

(71) Applicant: WIZAMA, Chateaugiron (FR)

(72) Inventors: Franck BOTTA, Chateaugiron (FR); Florent GUITTON, Amanlis (FR)

(73) Assignee: WIZAMA, Chateaugiron (FR)

(21) Appl. No.: 17/787,717

(22) PCT Filed: Dec. 22, 2020
(86) PCT No.: PCT/EP2020/087585

§ 371 Date: Jun. 21, 2022

(30) Foreign Application Priority Data
Dec. 26, 2019 (FR) 1915607

(51) Int. Cl. G06V 10/60; G06V 10/141; G06V 10/25; G06V 20/66; G06T 7/70; A63F 9/04

(52) U.S. Cl. CPC G06V 10/60; G06V 10/141; G06V 10/25; G06V 20/66; G06T 7/70; A63F 9/04; G06T 2207/10048

(57) ABSTRACT

A device for determining a face of a dice resting on a surface allowing an optical signal to pass, the dice being composed of a plurality of faces each including a visual marking uniquely identifying the face, and the device including: illumination means for illuminating a face of a dice through the surface, the illumination means being placed under the surface and oriented in the direction of the surface, the illumination means including a plurality of optical signal sources disposed at various positions under the surface; means for acquiring at least one image of the optical signals reflected by the face of the dice resting on the surface, the acquisition means being placed under the surface and being facing the surface; and an analysis unit including means for processing the image to determine the face of the dice resting on the surface allowing the optical signal to pass.

### TECHNICAL FIELD

The present invention relates to the field of connected interactive board games and relates more particularly to a dice track device for automatically identifying a visible face of a dice placed on the dice track.

### PRIOR ART

A board game usually uses specially designed equipment such as a game board, cards, pieces, dice or supports. To be able to play a large number of games, a board game enthusiast must therefore have available numerous items of equipment. Connected interactive board games have the advantage of being able to offer different games on the same game system. This makes it possible for example for a board game enthusiast to easily access new games as they appear or to test a board game that he wishes to discover while limiting the quantity of equipment necessary.

The use of a connected interactive board game means that the game system identifies the result of each action performed by players, such as for example playing a card, moving a piece or throwing a dice. One existing solution consists in identifying a game element by means of a radio-identification tag emitting a signal that is received, under certain conditions, by an antenna connected to the game system. Such a radio-identification tag also makes it possible to distinguish each item of game equipment and makes it possible for example to identify the value of a card played.

However, the use of radio-identification tags may generate interference when several objects are played at the same time in a limited zone, such as for example when one or more dice are thrown, which limits the reliability of detection of the result of an action. In addition, the solutions using radio-identification technologies require the use of specific equipment equipped with radio-identification tags. This gives rise to constraints on dimensions of the game elements, which must therefore have a minimum size. The use of such specific equipment furthermore involves an additional cost on the one hand, and does not make it possible to adapt to normally used game elements that do not include a radio-identification tag. More particularly, in the field of role playing, a player is in the habit of playing with his own dice.

It is then desirable to overcome these drawbacks of the prior art.

It is in particular desirable to provide a solution that makes it possible to detect the result of an action of throwing a dice without using radio-identification technology. It is furthermore desirable to provide a solution that makes it possible to identify the result of a simultaneous throw of several dice. It is also desirable to provide a solution that makes it possible to use various types of dice having different shapes and a variable number of faces. It is also desirable to provide a compact solution that does not interfere with a movement of throwing dice performed by a player.

### DISCLOSURE OF THE INVENTION

One object of the present invention is to propose a device for determining a face of at least one dice resting on a surface allowing an optical signal to pass, the at least one dice being composed of a plurality of faces each comprising a visual marking uniquely identifying the face. The device comprises: illumination means for illuminating a face of at least one dice through the surface allowing the optical signal to pass, the illumination means being placed under the surface allowing the optical signal to pass and oriented in the direction of the surface allowing the optical signal to pass, the illumination means comprising a plurality of optical-signal sources disposed at various positions under the surface allowing the optical signal to pass, means for acquiring at least one image of the optical signals reflected by the face of the at least one dice resting on the surface allowing the optical signal to pass, the acquisition means being placed under the surface allowing the optical signal to pass and being oriented facing the surface allowing the optical signal to pass, and an analysis unit comprising means for processing the at least one image for determining the face of the at least one dice resting on the surface allowing an optical signal to pass.

Thus it is possible to automatically identify a face of a dice placed without using radio-identification technology. Furthermore, the device does not interfere with a movement of throwing a dice of a player.

According to a particular embodiment, the device furthermore comprises an opaque wall surrounding the means for acquiring the at least one image and the illumination means, the opaque wall joining the edges of the surface allowing the optical signal to pass and a base of the device so that only the optical signals passing through the surface allowing the optical signal to pass are detected by the means for acquiring the at least one image.

Thus the presence of parasitic optical signals is limited and the identification of a face of a dice is rapid and reliable.

According to a particular embodiment, the surface allowing the optical signal to pass is transparent in a spectral range of the infrared and opaque in the visible, and the spectral detection range of the means for acquiring the at least one image is located in the spectral range of the infrared.

Thus the device can be used in a dark environment. In addition, the acquisition and illumination means of the device are hidden from the user.

According to a particular embodiment, the means of the device for acquiring the at least one image acquire the at least one image with a detection angle of 200°.

Thus an image of the whole of the surface allowing the optical signal to pass can be acquired. In addition, the device is compact since the surface allowing the optical signal to pass is wide for a limited height of the device.

According to a particular embodiment, the means for processing the at least one image furthermore comprise: means for locating, on an image acquired by the acquisition means, a face of at least one dice resting on the surface allowing the optical signal to pass, referred to as the contact face, means for identifying, on the contact face located, the visual marking uniquely identifying the contact face, and means for determining, from the visual marking uniquely identifying the contact face, the visual marking uniquely identifying the face opposite to the contact face, from a look-up table associating, with each visual marking, the visual marking of the opposite face of a dice.

Thus it is possible to determine the result of a throw of one or more dice automatically without having recourse to radio-identification technology.

According to a particular embodiment, the optical-signal sources are grouped together in two groups of illumination means, a first group comprising a first set of light emitting diodes and a second group comprising a second set of light emitting diodes, the light emitting diodes being disposed at the periphery with respect to the surface allowing the optical signal to pass and regularly spaced apart, each light emitting diode in the first set of light emitting diodes being placed between two light emitting diodes in the second set of light emitting diodes. The device furthermore comprises: means for illuminating the surface allowing the optical signal to pass with only the first group of illumination means and means for illuminating the surface allowing the optical signal to pass with only the second group of illumination means, means for acquiring a first image when the surface allowing the optical signal to pass is illuminated by the first group of illumination means and for acquiring a second image when the surface allowing the optical signal to pass is illuminated by the second group of illumination means. The means for processing the at least one image of the device furthermore comprise: means for locating, in the first image, reflection zones, referred to as target zones, means for identifying source zones in the second image, each source zone being located in the second image at the location of a target zone of the first image, and means for replacing the target zones of the first image by the corresponding source zones of the second image in order to obtain a third image.

Thus the device makes it possible to determine the result of a dice throw reliably while avoiding erroneous determinations related to reflections.

The invention also relates to a method for determining a face of at least one dice resting on a surface allowing an optical signal to pass, the at least one dice being composed of a plurality of faces each comprising a visual marking uniquely identifying the face. The method comprises the steps of: illuminating, with illumination means, a face of the at least one dice through the surface allowing the optical signal to pass, the illumination means being placed under the surface allowing the optical signal to pass and oriented in the direction of the surface allowing the optical signal to pass, the illumination means comprising a plurality of optical-signal sources disposed at various positions under the surface allowing the optical signal to pass, acquiring, with acquisition means, at least one image of the optical signals reflected by the face of the at least one dice resting on the surface allowing the optical signal to pass, the acquisition means being placed under the surface allowing the optical signal to pass and being facing the surface allowing the optical signal to pass; and processing the at least one image to determine the face of the at least one dice resting on the surface allowing the optical signal to pass.

According to a particular embodiment, the method furthermore comprises the steps of: locating, on an image acquired by the acquisition means, a face of the at least one dice resting on the surface allowing the optical signal to pass, referred to as the contact face; identifying, on the contact face located, the visual marking uniquely identifying the contact face; and determining, from the visual marking uniquely identifying the contact face, the visual marking uniquely identifying the face located opposite the contact face, from a look-up table associating with each visual marking the visual marking of the opposite face.

According to a particular embodiment, the optical-signal sources are grouped together in two groups of illumination means, a first group comprising a first set of light emitting diodes and a second group comprising a second set of light emitting diodes, the light emitting diodes being disposed at the periphery with respect to the surface allowing the optical signal to pass and spaced apart regularly, each light emitting diode in the first set of light emitting diodes being placed between two light emitting diodes in the second set of light emitting diodes, and the method furthermore comprises the steps of: illuminating the surface allowing the optical signal to pass with only the first illumination and acquiring a first image; illuminating the surface allowing the optical signal to pass with only the second illumination and acquiring a second image; locating reflection zones, referred to as target zones, in the first image; identifying source zones in the second image, each source zone being located in the second image at the location of a target zone of the first image; and replacing the target zones of the first image by the corresponding source zones of the second image to perform the step of identifying the face of the dice resting on the surface allowing the optical signal to pass.

According to a particular embodiment, the steps of locating the target zones in the first image and identifying the source zones in the second image are preceded by a step of applying a distortion correction treatment to each first image and second image.

Recognising a face of a dice is thus facilitated despite the use of acquisition means with a wide angle.

According to a particular embodiment, the method furthermore comprises a step of identifying a dice shape from a contact face located on an image, the dice shape being dependent on a number of sides of the contact face or dependent on an angle formed by the sides of the contact face, and wherein, during the step of determining the visual marking uniquely identifying the face located opposite the contact face of a dice, a look-up table associated with the identified dice shape is selected, a look-up table being established for each dice shape.

Thus it is possible to play with various types of dice, with a variable number of faces.

According to a particular embodiment, during the step of locating a contact face of the at least one dice, the circumferences of the face are detected to identify the number of faces of the dice.

Thus the reliability of detection of the number of faces of a dice is improved.

The invention also relates to a system comprising a device as described previously and comprising a dice comprising a contrasted circumference for each face of the dice, the contrasted circumference being placed on each edge of the dice and being in a colour that contrasts with the faces of the dice.

The invention also relates to a computer program that can be stored on a medium and/or downloaded from a communication network, in order to be read by a processor, and which comprises instructions for implementing the method mentioned above in any one of the embodiments thereof, when said program is executed by the processor.

The invention also relates to an information storage medium storing the computer program as described above.

### BRIEF DESCRIPTION OF THE DRAWINGS

The features of the invention mentioned above, as well as others, will emerge more clearly from the reading of the following description of at least one example embodiment, said description being made in relation to the accompanying drawings, among which:

FIG. 1A illustrates schematically a view in cross section of a device for determining a face of a dice;

FIG. 1B illustrates schematically a plan view of the device for determining a face of a dice;

FIG. 2A illustrates schematically a dice;

FIG. 2B illustrates schematically a dice comprising a circumference contrasted on its edges,

FIG. 3 illustrates schematically a method for determining a face of a dice; and

FIG. 4 illustrates schematically an example of hardware architecture of an analysis unit of the device for determining a face of a dice.

### DETAILED DISCLOSURE OF EMBODIMENTS

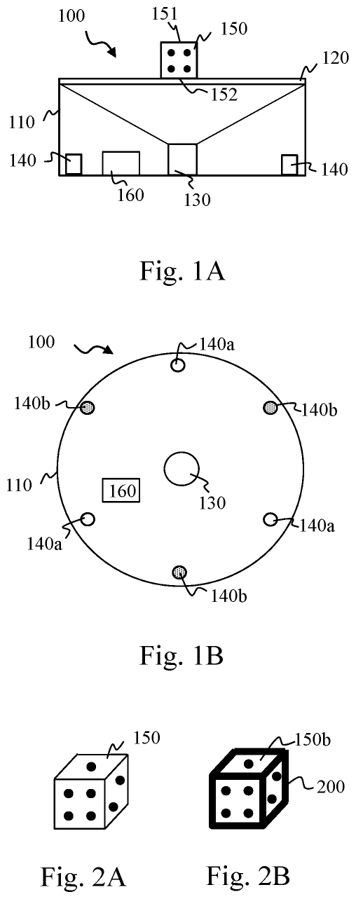

FIG. 1A illustrates schematically a device 100 for determining a face of at least one dice 150, in cross-sectional view. A dice 150 is composed of a plurality of faces each comprising a visual marking uniquely identifying the face. The device 100 comprises a surface 120 allowing an optical signal to pass, such as a horizontal window maintained in height with respect to a base of the device 100. When a dice 150 is thrown onto the surface 120 allowing the optical signal to pass and stabilises, the dice 150 placed on the surface 120 allowing the optical signal to pass comprises a face, referred to as the visible face 151, oriented upwards, and a face resting on the surface 120 allowing the optical signal to pass, referred to as the contact face 152 and opposite to the visible face 151. The device 100 makes it possible to determine the face of at least one dice 150 resting on the surface 120 allowing the optical signal to pass, referred to as the contact face 152, and to deduce therefrom the face opposite to the contact face 152, referred to as the visible face 151 of the at least one dice 150. In other words, the device 100 makes it possible to determine the visual marking uniquely identifying the visible face 151 of the dice 150.

The device 100 comprises illumination means 140 placed under the surface 120 allowing the optical signal to pass and oriented in the direction of the surface 120 allowing the optical signal to pass so as to illuminate, through the surface 120 allowing the optical signal to pass, the contact face 152 of a dice 150 placed on the surface 120 allowing the optical signal to pass. The illumination means 140 comprise a plurality of optical-signal sources, such as light emitting diodes, disposed at various positions under the surface 120 allowing the optical signal to pass. In a particular embodiment, the optical-signal sources are disposed at the periphery with respect to the surface 120 allowing the optical signal to pass and are regularly spaced apart.

The device 100 furthermore comprises means 130 for acquiring at least one image of the optical signals reflected by at least the contact face 152 of a dice 150. The acquisition means 130 are placed under the surface 120 allowing the optical signal to pass and oriented facing the surface 120 allowing the optical signal to pass. Thus it is possible to acquire an image of a contact face 152 of a dice 150 placed on the surface 120 allowing the optical signal to pass while the illumination means 140 illuminate said contact face 152 through the surface 120 allowing the optical signal to pass.

In a particular embodiment, the acquisition means 130 can acquire an image with a field of view of between 140 and 200° and the surface 120 allowing the optical signal to pass measures for example 10 cm in radius. The surface 120 allowing the optical signal to pass may have a different dimension, depending on the type of lens used in the acquisition means. The acquisition means 130 may for example be a camera or a photographic apparatus.

It should be noted here that, in a variant, the acquisition means 130 may consist of a plurality of cameras that each have a smaller field of view, for example between 60 and 80°.

The surface 120 allowing the optical signal to pass is transparent in the spectral range of detection of the acquisition means 130, so as to be able to acquire an image of a contact face 152 of a dice 150 through the surface 120 allowing the optical signal to pass. In a particular embodiment, the acquisition means 130 have a spectral range of detection in the infrared and the optical-signal sources of the illumination means 140 are infrared light emitting diodes or LEDs the spectral range of emission of which is included or partially included in the spectral range of detection of the infrared camera. The surface 120 allowing the optical signal to pass is furthermore transparent in the infrared. Thus it is possible to use the device 100 in dark environments. The surface 120 allowing the optical signal to pass may furthermore be opaque in the visible spectrum. Thus the elements located inside the casing 120 such as the acquisition means 130 or the illumination means 140 are not visible to the players.

The device 100 furthermore comprises an analysis unit 160. The analysis unit 160 is connected to the illumination means 140 and to the acquisition means 130 in order to send instructions to them. The analysis unit 160 furthermore recovers the images acquired by the acquisition means 130 and can apply image processing operations to said images in order to determine a contact face 152 of a dice 150 placed on the surface 120 allowing the optical signal to pass. The analysis unit 160 furthermore comprises an interface for communicating to a connected interactive game system making it possible to transmit an identified visible face 151. In other words the analysis unit 160 makes it possible to transmit a result of a dice throw so that the result is taken into account as a game progresses.

The device 100 thus makes it possible to automatically identify a visible face 151 of a dice 150 by optical means and therefore without using radio-identification technology. A visible face 151 of a dice 150 not equipped with radio-identification tags can therefore be identified by a connected interactive game system, which limits the cost of game equipment and enables a player to play conventional dice 150. In addition, the device 100 comprises optical-detection and analysis elements placed under the surface 120 allowing the optical signal to pass, which facilitates the use of said device 100. In particular, a movement of throwing dice 150 of a player is not interfered with by detection elements located around and above the surface 120 allowing the optical signal to pass.

The device 100 may furthermore comprise a casing 110 containing the acquisition means 130, the illumination means 140 and optionally the analysis unit 160. The casing 110 is closed at the top and at the bottom respectively by the surface 120 allowing the optical signal to pass and by a base, and furthermore comprises an opaque wall joining the edges of the surface 120 allowing the optical signal to pass to the base of the device 100. The casing 110 can be deposited on a horizontal support such as a table in order to be used. The device 110 is thus compact and easily transportable, and the illumination means 140 and the acquisition means 130 are protected from external impacts and are not visible to a user. In addition to concealing the content of the casing from users, the opaque wall makes it possible to prevent optical signals that are not transmitted or reflected by the surface 120 allowing the optical signal to pass from being detected by the acquisition means 130. Thus only optical signals passing through the surface 120 allowing the optical signal to pass or optical signals coming from the illumination means and reflected on the surface 120 allowing the optical signal to pass can be detected by the acquisition means 130, which limits the detection of parasitic optical signals.

FIG. 1B schematically illustrates the device 100 for determining a face of at least one dice 150, in plan view. The casing 110 is circular in this example embodiment. The acquisition means 130 are centred in the device 100 so as to be able to image the whole of the surface 120 allowing the optical signal to pass. The illumination means are divided into two groups of illumination means, a first group 140a comprising a first set of light emitting diodes, and a second group 140b comprising a second set of light emitting diodes. Each illumination 140a and 140b comprises light emitting diodes evenly distributed over the periphery of the casing 110 so that, when only one group 140a or 140b is switched on, the illumination on the surface 120 allowing the optical signal to pass is centred and even. Each light emitting diode in the first set of light emitting diodes is placed between two light emitting diodes in the second set of light emitting diodes. Each group 140a and 140b of illumination means can illuminate the surface 120 allowing the optical signal to pass independently. Thus the surface 120 allowing the optical signal to pass can be illuminated either by the first group 140a or by the second group 140b, or by both of the two groups 140a and 140b.

FIG. 2A illustrates schematically a dice 150 in perspective. In this example, the dice 150 has six faces. Dice 150 of various types, in other words dice comprising a number of faces different from six, can alternatively be used with the device 100, such as for example dice with four faces, with ten faces, with twelve faces or with twenty faces. Each type of dice 150 can be identified by a specific shape of its faces. For example, a dice 150 with four faces comprises triangular faces, a dice 150 with ten faces comprises faces in the form of a quadrilateral, a dice 150 with twelve faces comprises pentagonal faces, a dice 150 with twenty faces comprises triangular faces.

FIG. 2B illustrates schematically in perspective a dice 150b comprising a contrasted circumference 200 for each face of the dice 150b. The contrasted circumference 200 is an element placed on the edges of the dice 150b and the thickness of which is between 0.5 and 3 mm with respect to the dimensions of a face of the dice 150. In addition, the contrasted circumference 200 has a colour that contrasts with the faces of the dice 150b. For example, the contrasted circumference 200 is black on a dice 150b having white faces. In other words, the colour of the contrasted circumference 200 can be easily distinguishable from the colour of the faces of the dice 150b by image processing. For example, a thresholding binarisation processing can be used to detect the contrast of a contact face 152 and thus easily identify the edges of a dice 150b. From the contour detected, applying a shape recognition method makes it possible to recognise the shape of the contact face 152 and therefore to identify the type of dice 150.

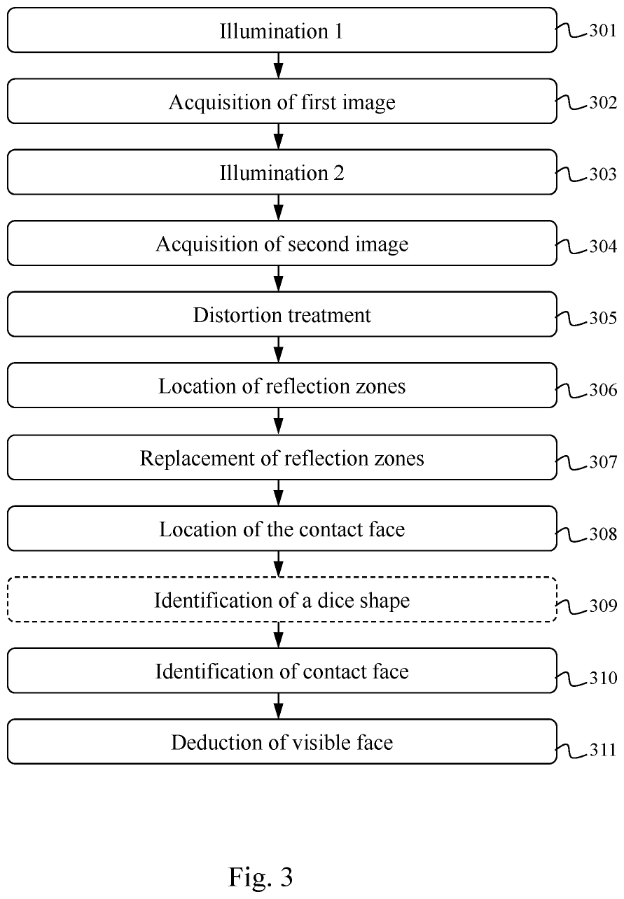

FIG. 3 illustrates schematically a method for determining a face of at least one dice 150. The detection method is implemented by the device 100 and more specifically by the analysis unit 160 of the device 100.

In a step 301, the device 100 illuminates the surface 120 allowing the optical signal to pass by means solely of the first group 140a of illumination means. In a step 302 simultaneous with the step 301, the device 100 acquires a first image by means of the acquisition means 130.

In a following step 303, the device 100 illuminates the surface 120 allowing the optical signal to pass by means solely of the second group 140b of illumination means. In a step 304 simultaneous with the step 303, the device 100 acquires a second image by means of the acquisition means 130.

In a following step 305, the device 100 applies a distortion-correction treatment to each of the first and second images, such as for example a treatment for correcting a pincushion distortion or a treatment for correcting a barrel distortion.

In a step 306, the device 100 locates reflection zones in the first image, referred to as target zones. A reflection zone is generated by a reflection of a light emitting diode in a group 140a or 140b of means of illumination on the surface 120 allowing the optical signal to pass and/or on a face of the dice 150 and corresponds on an image to a set of pixels having a light intensity level that is saturated or greater than the mean of the intensity of the pixels. A reflection zone thus masks optical signals coming from outside the surface 120 allowing the optical signal to pass and in particular optical signals coming from a contact face 152 of a dice 150.

The reflection zone is always the same and depends on the location of the diodes.

In the step 306, the device 100 furthermore identifies, in the second image, a source zone for each target zone of the first image. A source zone of the second image corresponds to the position of a target zone of the first image, and it therefore suffices to identify the position of the pixels of a target zone for finding the corresponding source zone in the second image. Since the group 140a or 140b of illumination means is different for acquiring the first image and for acquiring the second image, the reflection zones are not located at the same points in the first and in the second image. Thus, if each target zone corresponds to a reflection zone, each source zone corresponds to a zone without reflection.

In a following step 307, the device 100 replaces, in the first image, each target zone with the corresponding source zone of the second image to perform the step of identifying the face of the dice resting on the surface allowing an optical signal to pass.

For example, a third image is thus obtained. The third image obtained therefore does not comprise any reflection zone. It is then easier to locate and analyse a contact face 152 of a dice 150.

In order to attenuate variations in intensity located at the border of the source zones due to a difference in contrast between the first image and the second image, a treatment can furthermore be applied to the third image using an image fusion technique by means, for example, of Gaussian pyramids and/or Laplacian pyramids.

In a step 308, the device 100 applies to the third image a treatment for locating in the third image a contact face 152 of at least one dice 150. The device 100 thus selects in the third image, for each contact face 152 located, an image of a zone corresponding to the contact face 152 located. To locate a contact face 152, the device 100 can for example use a contour detection method for identifying the points of an image corresponding to an abrupt change in light intensity. In a particular embodiment, the device 100 is used with at least one dice 150b comprising a contrasted circumference 200 as described previously in relation to FIG. 2B, which facilitates the detection of contours and makes it possible to locate a contact face 152 more quickly and more reliably.

The device 100 can also use, alternatively or in addition to a contour detection method, a shape recognition or pattern recognition method aimed at identifying a computer pattern from an image. An automatic learning algorithm can be used for implementing the shape recognition method.

In an optional step 309, the device 100 identifies a shape of a dice 150 for each contact face 152 located according to a number of sides of the contact face 152 or according to an angle formed by the sides of the contact face 152.

In a step 310, the device 100 identifies, on each contact face 152 located, a visual marking uniquely identifying said contact face 152, such as a symbol or a number. The device 100 can perform the step 310 by using, in a similar manner to the step 308, a shape recognition method. The device 100 can furthermore perform a prior operation of thresholding binarisation for each contact face 152 located so as to distinguish a visual marking, such as black dots or a figure, on a background of the contact face 152, such as for example a white background. The device 100 can furthermore use a learning algorithm for identifying the visual marking uniquely identifying the contact face 152.

In a following step 311, the device 100 identifies by deduction a visual marking uniquely identifying the visible face 151 of each dice 150 the contact face 152 of which is identified. The device for this purpose uses a look-up table that associates with each visual marking uniquely identifying a face of a dice 150 the visual marking uniquely identifying the opposite face. The look-up table can be recorded in a memory included in the device 100. In a particular embodiment, a look-up table is established and recorded for each shape of a dice 150. The device 100 at step 311 selects the look-up table associated with the shape of the dice 150 identified during the step 309 for each contact face 152 and identifies the visual marking uniquely identifying the corresponding visible face 151 by means of said look-up table selected.

In a following step (not shown in the figures), the device 100 transmits information representing the visual marking uniquely identifying the visible face 151 of each dice 150 to a connected interactive game system. The connected interactive game system can thus detect a game action such as a throwable dice and identify the result of the throw of the dice. For example, the connected interactive game system can display the result of the throw of a dice on a screen. According to another example, the connected interactive game system can determine a following game action according to the result of the throw of a dice and provide to a user information relating to the following game action.

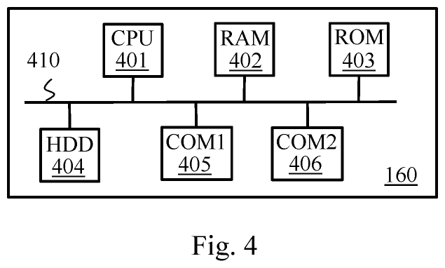

FIG. 4 illustrates schematically an example of hardware architecture of the analysis unit 160 of the device 100 for determining a face of a dice 150 according to a particular embodiment. The analysis unit 160 then comprises, connected by a communication bus 410: a processor, microprocessor or microcontroller or CPU (central processing unit) 401; a random access memory RAM 402; a read only memory ROM 403; a storage unit such as a hard disk HDD (hard disk drive) 404 or a storage medium reader, such as an SD (Secure Digital) card reader; a first communication interface COM1 405 enabling the analysis unit 160 to communicate at least with the illumination means 140 and the acquisition means 130 and a second communication interface COM2 406, for example of the radio type, making it possible to communicate with a connected interactive game system.

The processor 401 is capable of executing instructions loaded in the RAM 402 from the ROM 403, from an external memory (not shown), from a storage medium such as an SD card or from a communication network. When the analysis unit is powered up, the processor 401 is capable of reading instructions from the RAM memory 402 and executing them. These instructions form a computer program causing the complete or partial implementation, by the processor 401, of the method of the present invention described previously in relation to FIG. 3.

All or part of the method can be implemented in software form by executing a set of instructions by a programmable machine such as a DSP (digital signal processor) or a microcontroller, or be implemented in hardware form by a machine or a dedicated component, for example an FPGA (field-programmable gate array) or an ASIC (application-specific integrated circuit). In general terms, the analysis unit 160 comprises electronic circuitry adapted and configured for implementing the steps of the method described previously.

1. A device for determining a face of at least one dice resting on a surface allowing an optical signal to pass, the at least one dice being composed of a plurality of faces each comprising a visual marking uniquely identifying the face, wherein the device comprises:
circuitry configured to cause the device to perform:
illuminating, with illumination means, a face of at least one dice through the surface allowing the optical signal to pass, the illumination means being placed under the surface allowing the optical signal to pass and oriented in the direction of the surface allowing the optical signal to pass, the illumination means comprising a plurality of optical-signal sources disposed at various positions under the surface allowing the optical signal to pass; and
means for acquiring, with acquisition means, at least one image of the optical signals reflected by the face of the at least one dice resting on the surface allowing the optical signal to pass, the acquisition means being placed under the surface allowing the optical signal to pass and being oriented facing the surface allowing the optical signal to pass;
an opaque wall surrounding the acquisition means and the illumination means, the opaque wall joining the edges of the surface allowing the optical signal to pass and a base of the device so that only the optical signals passing through the surface allowing the optical signal to pass are detected by the acquisition means, and
an analysis unit comprising circuitry configured to cause the analysis unit to perform processing the at least one image for determining the face of the at least one dice resting on the surface allowing an optical signal to pass.

2. The device according to claim 1, wherein the surface allowing the optical signal to pass is transparent in a spectral range of the infrared and opaque in the visible, and wherein the spectral detection range of the acquisition means is located in the spectral range of the infrared.

3. The device according to claim 1, wherein acquiring the at least one image is performed with a field of view of between 140 and 200°.

4. The device according to claim 1, further comprising circuitry causing the device to perform, for processing the at least one image:
locating, on an image acquired by the acquisition means, a face of at least one dice resting on the surface allowing the optical signal to pass, referred to as the contact face,
identifying, on the contact face located, the visual marking uniquely identifying the contact face, and
determining, from the visual marking uniquely identifying the contact face, the visual marking uniquely identifying the face opposite to the contact face, from a look-up table associating, with each visual marking, the visual marking of the opposite face of a dice.

5. The device according to claim 4, wherein the optical-signal sources are grouped together in two groups of illumination means, a first group comprising a first set of light emitting diodes and a second group comprising a second set of light emitting diodes, the light emitting diodes being disposed at the periphery with respect to the surface allowing the optical signal to pass and regularly spaced apart, each light emitting diode in the first set of light emitting diodes being placed between two light emitting diodes in the second set of light emitting diodes, the device further comprising:
circuitry causing the device to perform:
illuminating the surface allowing the optical signal to pass with only the first group of illumination means and illuminating the surface allowing the optical signal to pass with only the second group of illumination means,
acquiring a first image when the surface allowing the optical signal to pass is illuminated by the first group of illumination means and for acquiring a second image when the surface allowing the optical signal to pass is illuminated by the second group of illumination means, and
circuitry causing the device to perform, for processing the at least one image:
locating, in the first image, reflection zones, referred to as target zones, said reflection zones corresponding on an image to a set of pixels having a light-intensity level that is saturated or higher than the mean of the intensity of the pixels,
identifying source zones in the second image, each source zone being located in the second image at the location of a target zone of the first image, and
replacing the target zones of the first image by the corresponding source zones of the second image in order to identify the face of the dice resting on the surface allowing the optical signal to pass.

6. A method for determining a face of at least one dice resting on a surface allowing an optical signal to pass, the at least one dice being composed of a plurality of faces each comprising a visual marking uniquely identifying the face, wherein the method causes a device to perform:
illuminating, with illumination means, a face of the at least one dice through the surface allowing the optical signal to pass, the illumination means being placed under the surface allowing the optical signal to pass and oriented in the direction of the surface allowing the optical signal to pass, the illumination means comprising a plurality of optical-signal sources disposed at various positions under the surface allowing the optical signal to pass,
acquiring, with acquisition means, at least one image of the optical signals reflected by the face of the at least one dice resting on the surface allowing the optical signal to pass, the acquisition means being placed under the surface allowing the optical signal to pass and being facing the surface allowing the optical signal to pass; an opaque wall surrounding the acquisition means and the illumination means, the opaque wall joining the edges of the surface allowing the optical signal to pass and a base of the device so that only the optical signals passing through the surface allowing the optical signal to pass are detected by the acquisition means, and
processing the at least one image to determine the face of the at least one dice resting on the surface allowing the optical signal to pass.

7. The method according to claim 6, wherein the method furthermore comprises:
locating, on an image acquired by the acquisition means, a face of the at least one dice resting on the surface allowing the optical signal to pass, referred to as the contact face,
identifying, on the contact face located, the visual marking uniquely identifying the contact face,
determining, from the visual marking uniquely identifying the contact face, the visual marking uniquely identifying the face located opposite the contact face, from a look-up table associating with each visual marking the visual marking of the opposite face.

8. The method according to claim 6, wherein the optical-signal sources are grouped together in two groups of illumination means, a first group comprising a first set of light emitting diodes and a second group comprising a second set of light emitting diodes, the light emitting diodes being disposed at the periphery with respect to the surface allowing the optical signal to pass and spaced apart regularly, each light emitting diode in the first set of light emitting diodes being placed between two light emitting diodes in the second set of light emitting diodes, the method further causes the device to perform:
illuminating the surface allowing the optical signal to pass with only the first group of illumination means and acquiring a first image;
illuminating the surface allowing the optical signal to pass with only the second group of illumination means and acquiring a second image;
locating reflection zones, referred to as target zones, in the first image; said reflection zones corresponding on an image to a set of pixels having a light-intensity level that is saturated or higher than the mean of the intensity of the pixels,
identifying source zones in the second image, each source zone being located in the second image at the location of a target zone of the first image; and
replacing the target zones of the first image by the corresponding source zones of the second image to perform identifying the face of the dice resting on the surface allowing the optical signal to pass.

9. The method according to claim 8, wherein locating the target zones in the first image and identifying the source zones in the second image are preceded by applying a distortion correction treatment to each first image and second image.

10. The method according to claim 7, wherein the method further causes the device to perform identifying a dice shape from a contact face located on an image, the dice shape being dependent on a number of sides of the contact face or dependent on an angle formed by the sides of the contact face, and wherein, during determining the visual marking uniquely identifying the face located opposite the contact face of a dice, a look-up table associated with the identified dice shape is selected, a look-up table being established for each dice shape.

11. The method according to claim 7, wherein, during locating a contact face of the at least one dice, the circumferences of the face are detected to identify the number of faces of the dice.

12. A system comprising a device according to claim 1 and comprising a dice comprising a contrasted circumference for each face of the dice, the contrasted circumference being placed on each edge of the dice and being in a colour that contrasts with the faces of the dice.

13. (canceled)

14. A non-transitory storage medium storing a computer program comprising instructions for implementing, by a device, the method according to claim 1, when said program is executed by a processor of said device.
